(19) United States
(12) Patent Application Publication
(10) Pub. No.: US 2024/0335891 A1
(43) Pub. Date: Oct. 10, 2024

(54) CIRCULAR SAW

(71) Applicant: MILWAUKEE ELECTRIC TOOL CORPORATION, Brookfield, WI (US)

(72) Inventors: Mark C. Hughes, Waukesha, WI (US); Leonard F. Mikat-Stevens, Milwaukee, WI (US); Jacob N. Zimmerman, Pewaukee, WI (US); Andrew J. Weber, Cudahy, WI (US); Adam N. Carter, Milwaukee, WI (US); Yangxue Yu, Brookfield, WI (US); Vincent M. Zornow, Milwaukee, WI (US)

(21) Appl. No.: 18/293,738

(22) PCT Filed: Aug. 2, 2022
(86) PCT No.: PCT/US22/39143

§ 371 Date: Jan. 30, 2024

Related U.S. Application Data
(60) Provisional application No. 63/228,214, filed on Aug. 2, 2021.

(51) Int. Cl. B23D 45/04; B23D 45/16; B23D 47/08; B23D 59/00

(52) U.S. Cl. CPC B23D 45/042; B23D 45/16; B23D 47/08; B23D 59/00

(57) ABSTRACT

A circular saw including a housing, a motor disposed within the housing, a spindle operable to be rotated by the motor, and a saw blade supported by the spindle for co-rotation therewith. The saw blade includes a hub portion located at a center of the saw blade and a blade portion extending therefrom. The hub portion is offset from the blade portion to define a pocket between the blade portion and the hub portion. The circular saw also includes a fastener securing the saw blade to the spindle. The fastener is at least partially recessed within the pocket.

### CROSS REFERENCE TO RELATED APPLICATION

This application claims the benefit of co-pending U.S. Provisional Patent Application No. 63/228,214 filed on Aug. 2, 2021, the entire content of which is incorporated herein by reference.

### FIELD OF THE DISCLOSURE

The present disclosure relates to power tools and, more particularly, to circular saws.

### BACKGROUND OF THE DISCLOSURE

Generally, circular saws include blades specifically to cut work pieces made of a variety of materials, such as, for example, metals, fiber, or wood.

### SUMMARY OF THE DISCLOSURE

The present disclosure provides, in another aspect, a circular saw including a housing, a motor disposed within the housing, a spindle operable to be rotated by the motor, and a saw blade supported by the spindle for co-rotation therewith. The saw blade includes a hub portion located at a center of the saw blade and a blade portion extending therefrom. The hub portion is offset from the blade portion to define a pocket between the blade portion and the hub portion. The circular saw also includes a fastener securing the saw blade to the spindle. The fastener is at least partially recessed within the pocket.

The present disclosure provides, in another aspect, a circular saw including a base, a housing supported by the base, a motor disposed within the housing, a blade guard coupled to the base, and a blade cover on a side of the blade guard opposite the housing. The blade cover and the base define an opening therebetween through which a saw blade can extend. The opening has a width of at least 10 millimeters.

In yet another aspect, a circular saw includes a housing, a motor disposed within the housing defining a motor outer diameter, and a base upon which the housing is supported. The base defines a workpiece contact surface along which a workpiece is slidable in a sliding direction, a top surface opposite the workpiece contact surface, a front end perpendicular to the sliding direction, and an opposite rear end perpendicular to the sliding direction. The base defines a length between the front end and the rear end. The circular saw also includes a spindle operable to be rotated by the motor, a saw blade supported by the spindle for co-rotation therewith about a rotational axis, and a pivot joint proximate the rear end of the base. The pivot joint pivotably couples the housing to the base about a pivot axis that is parallel with the rotational axis, permitting the saw blade to plunge into the workpiece in response to the housing being pivoted about the pivot axis toward the base. An outer diameter of the saw blade is 6 inches or less.

The invention provides, in another aspect, a circular saw including a base, a housing supported on the base, a motor disposed within the housing, a saw blade operable to be rotated by the motor about a rotational axis, and a handle coupled to the housing and rotatable relative to the housing from a first position, in which the handle is substantially perpendicular to the rotational axis, to a second position, in which the handle is substantially parallel with the rotational axis.

The invention provides, in an additional aspect, a circular saw including a base with a top surface, a bottom surface opposite the top surface, and an opening that extends through the top and bottom surfaces. The circular saw also includes a housing supported by the base, a motor disposed within the housing, a spindle operable to be rotated by the motor about a rotational axis, and a gear case coupled to the housing in which a gear train is located for transferring torque from the motor to the spindle. At least a bottom portion of the gear case is receivable within the opening and the bottom portion is positioned above the bottom surface of the base.

The invention provides, in another aspect, a circular saw including a housing, a motor disposed within the housing, a saw blade operable to be rotated by the motor about a rotational axis, and a base upon which the housing is supported. The base defines a workpiece contact surface along which a workpiece is slidable in a sliding direction. The circular saw also includes a riser coupled to the base and extendible from the workpiece contact surface to adjust a bevel angle of the saw blade relative to the workpiece.

Other aspects of the disclosure will become apparent by consideration of the detailed description and accompanying drawings.

### BRIEF DESCRIPTION OF THE DRAWINGS

FIG. 1 is a front perspective view of an embodiment of a circular saw according to the present disclosure.

FIG. 2 is a rear perspective view of the circular saw of FIG. 1.

FIG. 3 is a cross-sectional view of a gear train for the circular saw of FIG. 1.

FIG. 4 is cross-sectional view of an arbor assembly for the circular saw of FIG. 1.

FIG. 5 is a side cross-sectional view of the circular saw of FIG. 1.

FIG. 6 is a side perspective view of the circular saw of FIG. 1 with portions removed for clarity.

FIG. 7A is a bottom view of a portion of the circular saw of FIG. 1.

FIG. 7B is a bottom view of a portion of the circular saw of FIG. 1 with an alternative saw blade.

FIG. 8 is a cross-sectional side view of the circular saw of FIG. 1.

FIG. 9 is a perspective view of a circular saw according to another embodiment of the invention with a handle in a first position.

FIG. 10 is a perspective view of the circular saw of FIG. 9 with the handle in a second position different from the first position.

FIG. 11 is a side view of the circular saw of FIG. 9 illustrating the handle with a plurality of positions.

FIG. 12 illustrates a circular saw according to another embodiment of the invention, including a deployable riser.

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting. In addition, as used herein, the terms “front”, “rear”, “upper”, “lower”, and other directional terms are not intended to require any particular orientation, but are instead used for purposes of description only.

### DETAILED DESCRIPTION

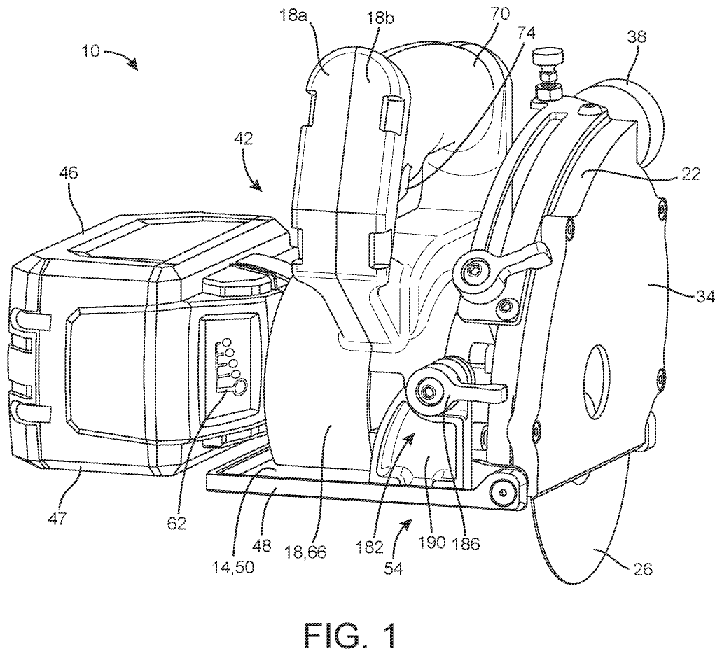

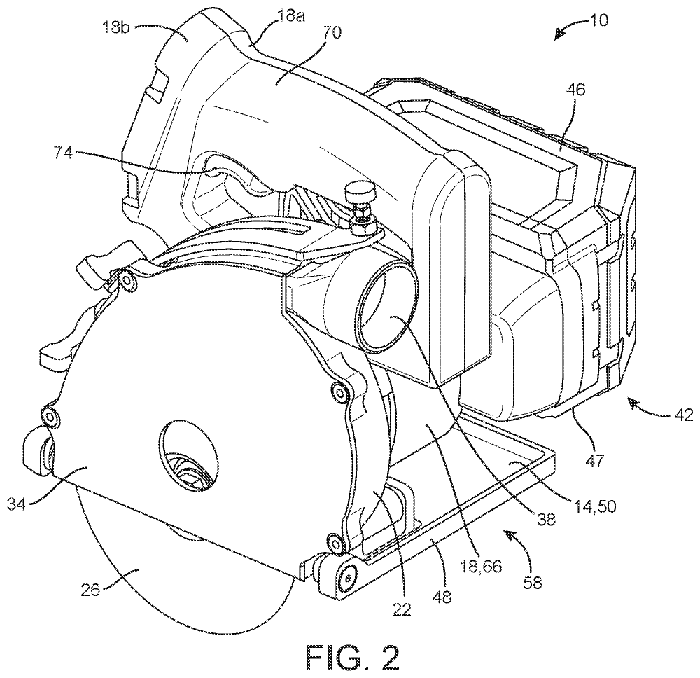

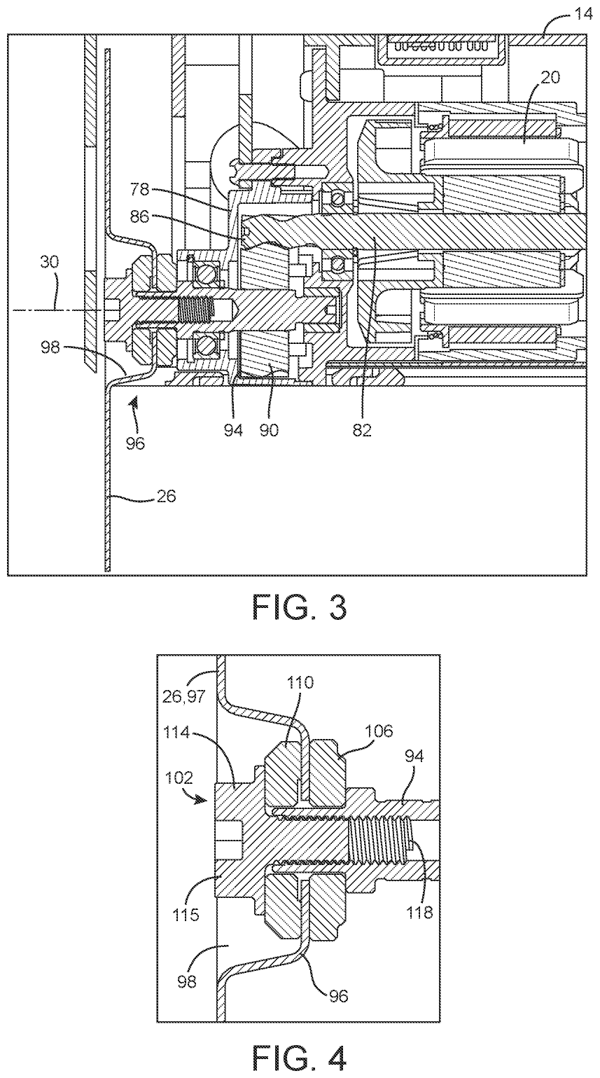

FIGS. 1 and 2 illustrate a circular saw 10 including a base 14 (e.g., a shoe), a housing 18 supported by the base 14, an electric motor 20 (FIG. 3) positioned within the housing 18, a blade guard 22 adjacent the housing 18, and a saw blade 26 at least partially positioned within the blade guard 22 and rotatable by the motor 20 to cut a workpiece. In some embodiments, the motor 20 may be a brushless motor. The motor 20 is operable to rotate the saw blade 26 about a rotational axis 30 (FIG. 3) that extends centrally through the saw blade 26.

The blade guard 22 includes a cover 34 that is removably coupled to the blade guard 22 with fasteners. A user may remove the cover 34 to gain access to the saw blade 26 to remove or replace the saw blade 26. A vacuum hose attachment 38 is coupled to the blade guard 22. A user may attach a vacuum hose to the vacuum hose attachment 38 to facilitate chip removal from the interior of the blade guard 22 during a cutting operation.

The circular saw 10 further includes a battery receptacle 42 supported by the housing 18. The battery receptacle 42 receives a battery pack 46 to power the motor 20. The illustrated battery pack 46 may be a power tool battery pack having a plurality of rechargeable battery cells. The battery cells may be lithium-based or have any other suitable chemistry. The battery pack 46 is positioned so that a bottom 47 of the battery pack 46 is approximately co-planar with a top surface 50 of the base 14. In addition, the bottom 47 of the battery pack 46 defines a clearance with a bottom side or workpiece contact surface 48 of the base 14 of 0.25 inches or less. In other embodiments, the clearance between the bottom 47 of the battery pack 48 and the workpiece contact surface 48 may be greater than 0.25 inches

The battery pack 46 is positioned more proximate a front end 54 (FIG. 1) of the base 14 than a rear end side 58 (FIG. 2) of the base 14. Positioning the battery pack 46 low and more forward improves the stability of the circular saw 10. The positioning of the battery pack 46 also allows for easy visibility of a status indicator 62 (FIG. 1) on the battery pack 46 which displays the amount of power left within the battery pack 46. In the illustrated embodiment, the battery pack 46 may be removed from the battery receptacle 42 to exchange for a new or fully charged battery pack.

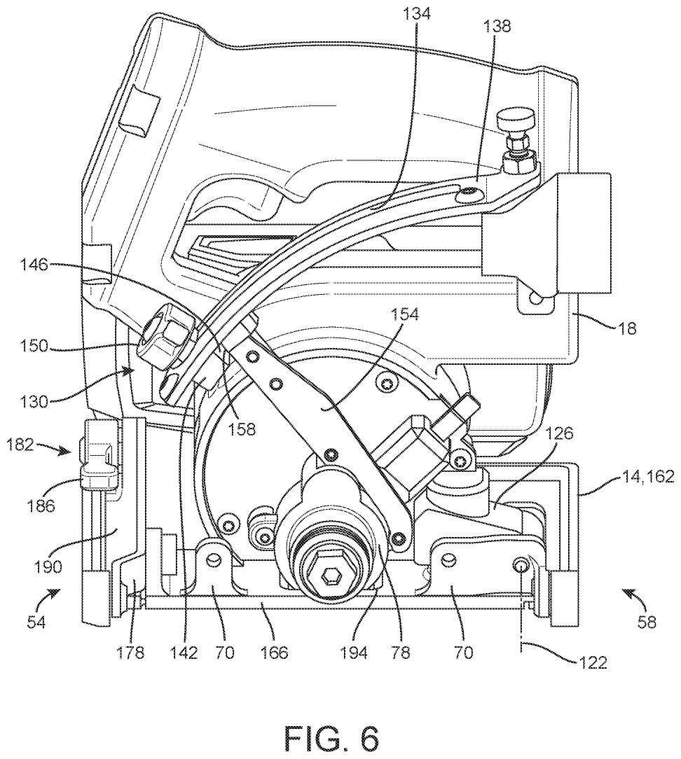

With continued reference to FIG. 1, the housing 18 is defined by two clamshell halves 18a, 18b that are coupled together to define a motor housing 66 and a handle 70. The illustrated handle 70 is a closed loop handle and includes a trigger 74 that is operable to power the motor 20. A gear case 78 (FIG. 6) extends from the motor housing 66 towards the blade guard 22. The gear case 78 houses a gear train that transfers torque from the motor 20 to the saw blade 26. With reference to FIG. 3, the motor 20 includes an output shaft 82 with a beveled pinon 86 that extends from the motor housing 66 into the gear case 78. The pinon 86 transfers torque from the motor 20 to a beveled driven gear 90 that is supported within the gear case 78. The driven gear 90 supports a spindle 94 that is concentric with the rotational axis 30. The spindle 94 supports the saw blade 26 as will be discussed in more detail below.

In the illustrated embodiment, and as shown in FIGS. 3 and 4, the saw blade 26 includes a hub portion 96 located at the center of the saw blade 26 and a blade portion 97 extending therefrom. The hub portion 96 is offset from the blade portion 97 to define a pocket 98 between the blade portion 97 and the hub portion 96. In other words, the hub portion 96 has an annular wall with a central axis that is generally aligned with the axis 30 (generally perpendicular to the blade portion 97 of the saw blade 26, and an end wall that defines the pocket 98. In some embodiments, the saw blade 26 may not include the pocket 98. For example, the hub portion 96 and the blade portion 97 may be co-planar, such as a flush cut blade or a flat blade.

FIG. 4 illustrates an arbor assembly 102 that secures the saw blade 26 to the spindle 94. The arbor assembly 102 includes an inner flange 106, an outer flange 110, and a fastener 114. The inner flange 106 is positioned between the gear case 78 and the saw blade 26 and the outer flange 110 is positioned within the pocket 98. The fastener 114 includes a head 115 that is recessed within the pocket 98 when the saw blade 26 is coupled to the spindle 94. In some embodiments, the fastener 114 may be a mounting bolt threaded to the spindle 94. In other embodiments, the fastener 114 may be a mounting nut threaded to the spindle 94. The fastener 114 extends through the outer flange 110, the saw blade 26, and the inner flange 106 and into a threaded bore 118 of the spindle 94. External threads on the fastener 114 engage internal threads on the spindle 94 to secure the saw blade 26 to the spindle 94 for co-rotation therewith. The pocket 98 and the arbor assembly 102 allow the saw blade 26 to perform approximately flush cuts with a vertical surface due to the head 115 of the fastener 114 being recessed within the pocket 98.

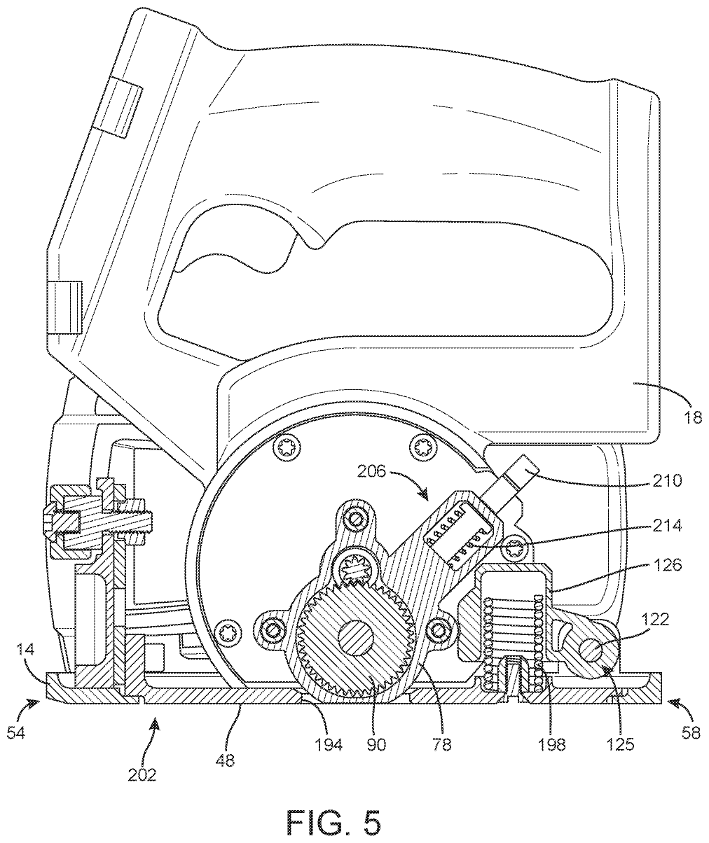

With reference to FIGS. 5 and 6, the housing 18, the gear case 78, and the saw blade 26 are all pivotably mounted to the base 14 about a pivot joint 125. Specifically, the pivot joint 125 includes a pivot bracket 126 that is coupled to the housing 18 to facilitate pivoting the housing 18 relative to the base 14 about a pivot axis 122 that is parallel with the rotational axis 30. The pivot joint 125 is positioned proximate the rear end 58 of the base 14. A plunge depth stop 130 (FIG. 6) is supported on the blade guard 22 to limit the depth the saw blade 26 is able to cut into a workpiece. The plunge depth stop 130 is movably supported within a slot 134 of a depth gage bracket 138. The depth gage bracket 138 may include markings that correlate to the depth of a cut. The plunge depth stop 130 includes a depth body 142 with a stop surface 146 and a lock knob 150. The lock knob 150 is rotatable to clamp the depth body 142 on the depth gage bracket 138. A user may loosen the lock knob 150 to adjust the position of the stop surface 146 and tighten the lock knob 150 to secure the plunge depth stop 130 in place. A bracket arm 154 includes a first end that is coupled to the gear case 78, and a second end that defines a stop surface 158. The stop surface 158 of the bracket arm 154 abuts the stop surface 146 of the depth body 142 when the housing 18 pivots relative to the base 14 about the pivot axis 122 to prevent the saw blade 26 from extending any further below the base 14.

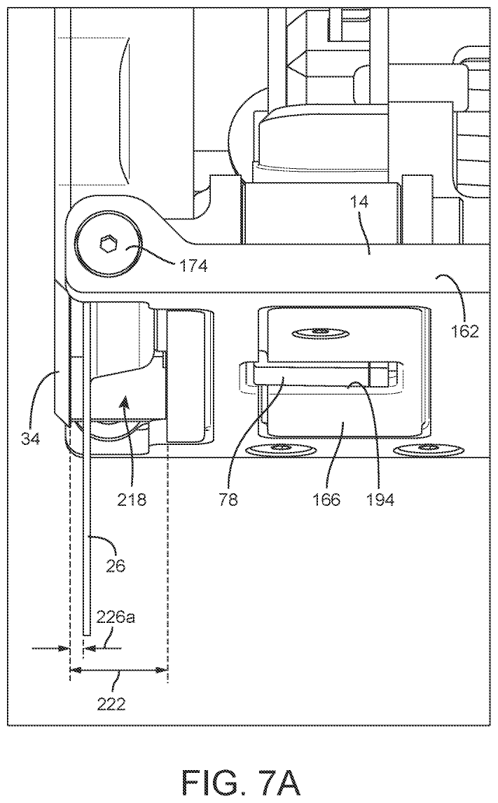

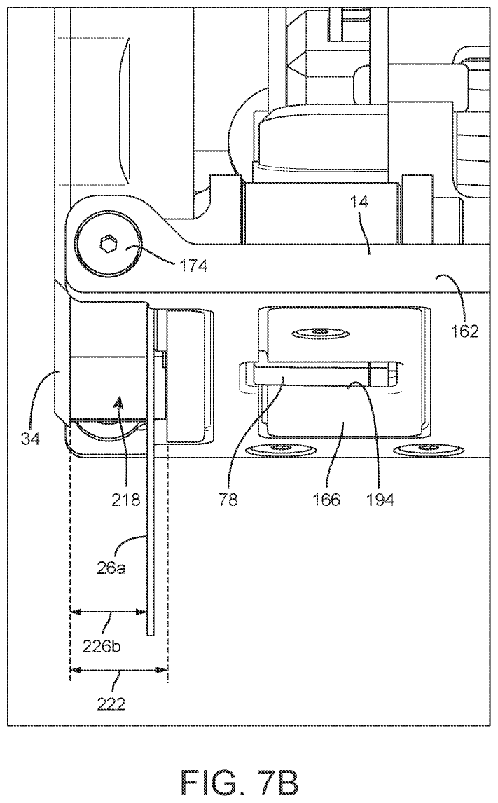

Referencing FIGS. 6 and 7, the base 14 includes an outer portion 162 and an inner portion 166 that is pivotably coupled to the outer portion 162 to adjust a bevel angle of cut during a cutting operation. Mounts 170 (FIG. 6) on the inner portion 166 of the base 14 couple the inner portion 166 of the base 14 to the blade guard 22 for co-pivotal movement therewith. A fastener 174 (FIG. 7) couples the inner portion 166 to the outer portion 162 adjacent the rear end 58 of the base 14. A bevel bracket 178 couples the inner portion 166 of base 14 to the outer portion 162 of the base 14 adjacent the front end 54 of the base 14. The bevel bracket 178 includes a slot (not shown) that a bevel lock 182 extends through to secure the saw blade 26 at a specific bevel angle relative to the base 14. The bevel lock 182 includes an actuator 186 that may be rotated a first direction (e.g., clockwise) to clamp the bevel bracket 178 to an arcuate bracket 190 (FIG. 1) that is fixed to the outer portion 162 of the base 14. Alternatively, the actuator 186 may be rotated a second direction (e.g., counter-clockwise) to loosen the clamping force between the arcuate bracket 190 and the bevel bracket 178, allowing the bevel angle of the saw blade 26 to be adjusted relative to the base 14.

As shown in FIGS. 5-7, the inner portion 166 of the base 14 includes an opening 194 that allows a bottom portion of the gear case 78 to extend through while making a plunge cut. The opening 194 allows for improved cutting depth when making a plunge depth with a smaller diameter saw blade. In addition, the circular saw 10 includes a biasing member (e.g., a spring 198) (FIG. 5) that biases the gear case 78 to a position where a bottom of the gear case 78 does not extend pass the workpiece contact surface 48 of the base 14. The spring 198 is positioned between the pivot bracket 126 and the base 14 to allow relative movement between the base 14 and the housing 18. As such, the spring 198 biases the pivot bracket 126, the housing 18, the gear case 78, and saw blade 26 away from the base 14. As described above, a user, while making a plunge cut, may push against the bias of the spring 198 to add extra depth to the cut. This may be particularly advantageous when the front end 54 of the base 14 encounters a vertical surface. The front end 54 of the base 14 would contact the vertical surface preventing the saw blade 26 from continuing the cut. However, a user may press the housing 18 against the bias of the spring 198 to move the housing 18 and the gear case 78 into the opening 194 of the base 14 allowing the saw blade 26 to cut closer to the vertical surface. A user may then release the pressure applied to the spring 198 to allow the spring 198 to bias the housing 18 and gear case 78 back to its original position. Alternatively, in some embodiments, the spring 198 may bias the base 14 in a direction opposite the sliding direction so that when the front end 54 of the base 14 encounters a vertical surface, a user may apply pressure against the bias of the spring 198 to move the base 14 relative to the housing 18 allowing the saw blade 26 to make a cut closer to the vertical surface while still protecting the saw blade 26.

With additional reference to FIG. 5, the circular saw 10 includes a braking mechanism 206. The braking mechanism 206 is supported by the gear case 78 and includes a lever 210 and a spring 214. The lever 210 includes a brake pad (not shown) that is positioned adjacent the driven gear 90. The brake pad is configured to selectively engage the driven gear 90 to inhibit rotation of the saw blade 26 in case of an emergency. The spring 214 biases the lever 210 away from the driven gear 90 to prevent the brake pad from engaging the driven gear 90 in a normal state. A user may depress the lever 210 against the bias of the spring 214 to engage the brake pad with a portion of the driven gear 90 to inhibit rotation of the saw blade 26.

Moving to FIGS. 7A and 7B, a blade opening 218 is defined between the blade cover 34 and the base 14 that the saw blade 26 extends through. The opening 218 defines a width 222 between the blade cover 34 and the base 14. The width 222 is within a range between 10 millimeters and 20 millimeters. In other embodiments, the width 222 may be within a range between 8 millimeters and 16 millimeters. In some embodiments, the width 222 is at least 10 millimeters. In further embodiments, the width 222 may be less than 8 millimeters or more than 20 millimeters. The opening 218 is larger compared to blade openings for other circular saws to accommodate a saw blade with a recessed arbor, as illustrated in FIG. 7A, as well as a flush cut or flat saw blade, as illustrated in FIG. 7B. For example, a first saw blade 26 with the pocket 98 as described above can be used or a second saw blade 26a that includes a hub portion and a blade portion that are co-planar. When the first saw blade 26 is coupled to the spindle 94 for co-rotation therewith, a first distance 226a (FIG. 7A) between the blade cover 34 and the first saw blade 26 is less than a second distance 226b (FIG. 7B) between the blade cover 34 and the second blade 26b when the second saw blade 26a is alternatively coupled to the spindle 94 for co-rotation therewith.

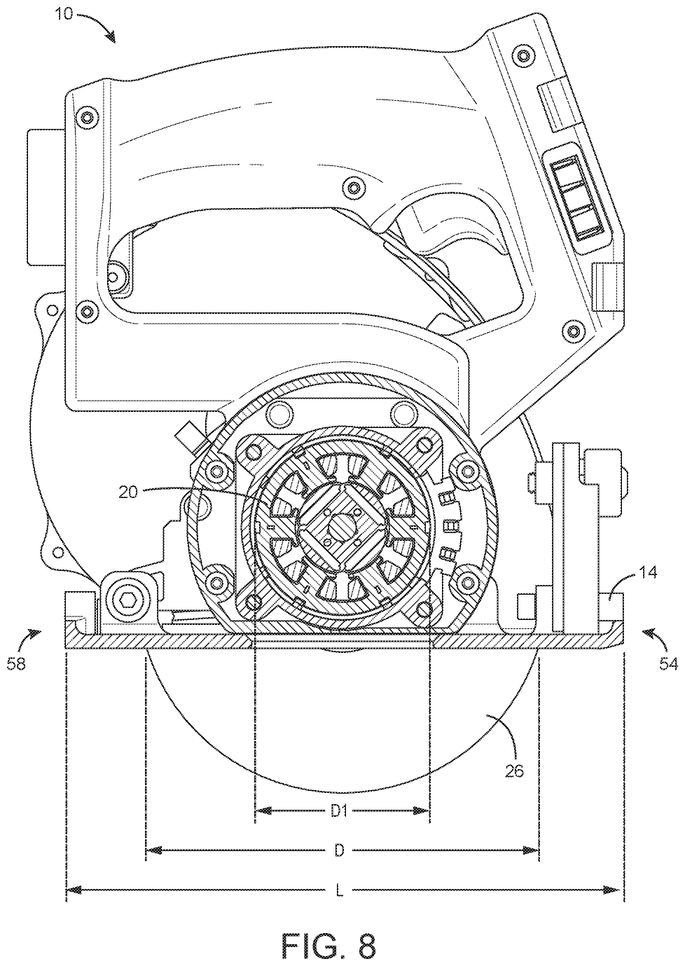

With reference to FIG. 8, the circular saw 10 includes a length L that is defined between the front end 54 and the rear end 58 of the base 14. The length L is in a range between 6 inches and 7 inches. Specifically, the length L of the circular saw 10 is 6.5 inches. In other embodiments, the length L of the circular saw 10 may be more than 6 inches or less than 7 inches. In addition, an outer diameter D of the saw blade 26 is in a range between 4 inches and 6 inches. Specifically, the outer diameter D of the saw blade 26 is 4.5 inches. In other embodiments, the outer diameter D of the saw blade 26 may be less than 4 inches or more than 5 inches. In alternate embodiments, the diameter D is less than 6 inches. As such, a ratio between the length L of the circular saw 10 and the outer diameter D of the saw blade 26 is within a range between 1.2 and 1.75. In some embodiments, the ratio between the length L of the circular saw 10 and the outer diameter D of the saw blade 26 is 1 or greater. In addition, the motor 20 has a motor outer diameter DI that may be within a range between 2 inches and 3 inches. Specifically, the motor outer diameter DI may be 2.52 inches. In other embodiments, the motor outer diameter DI may be less than 2 inches or greater than 2 inches. A ratio between the outer diameter D of the saw blade 26 and the motor outer diameter DI is within a range between approximately 1.3 and 2.5. In other embodiments, the ratio between the outer diameter D of the saw blade 26 and the motor outer diameter DI may be between approximately 1.5 and 2. In further embodiments, the ratio between the outer diameter D of the saw blade 26 and the motor outer diameter DI may be less than approximately 1.3 or more than approximately 2.5.

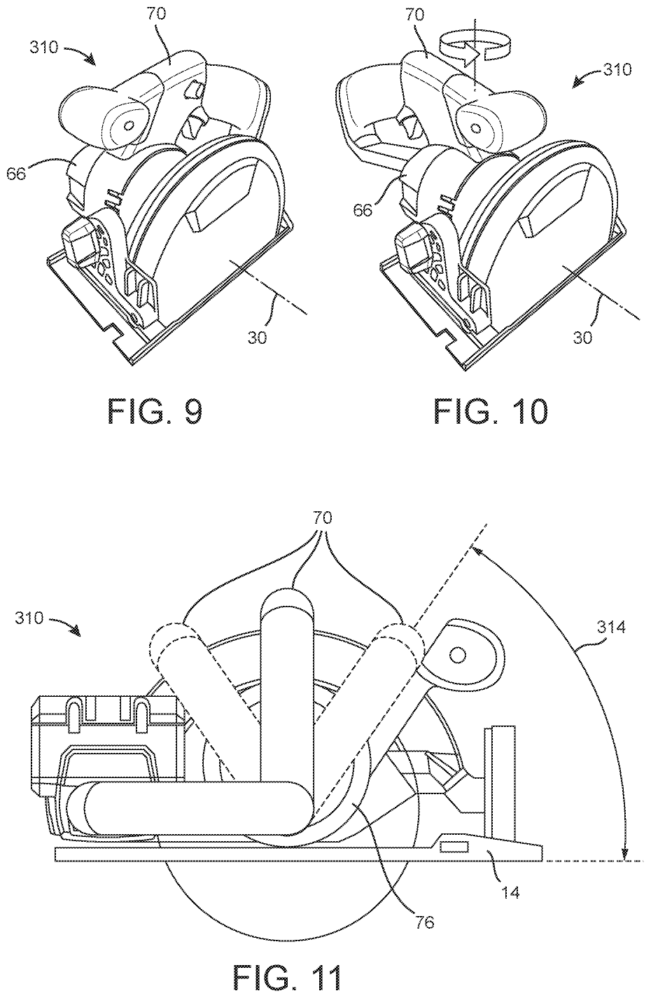

FIGS. 9-11 illustrates a circular saw 310 according to another embodiment of the invention. The circular saw 310 is similar to the circular saw 10 discussed above with like features being represented with like reference numerals. The circular saw 310 includes a handle 70 that is rotatable relative to the motor housing 66 to different positions. For example, the handle 70 has a first position (FIG. 9) in which an the handle 70 is substantially perpendicular to the rotational axis 30 of the saw blade 26, and a second position (FIG. 10) in which the handle 70 is substantially parallel to the rotational axis 30 of the saw blade 26. As shown in FIG. 11, the handle 70 is pivotable to a plurality of angular positions about the motor housing 66 (e.g., between the second position to a third position in which the handle 70 is oriented at an angle greater than or less than 90 degrees with the base 14 relative to the second position). In other words, when the handle 70 is in the plurality of angular positions, the handle 70 forms an oblique angle 314 with the base 14. Pivoting the handle 70 relative to the motor housing 66 allows a user to improve their visibility and handling for certain cuts (e.g., a nosing cut).

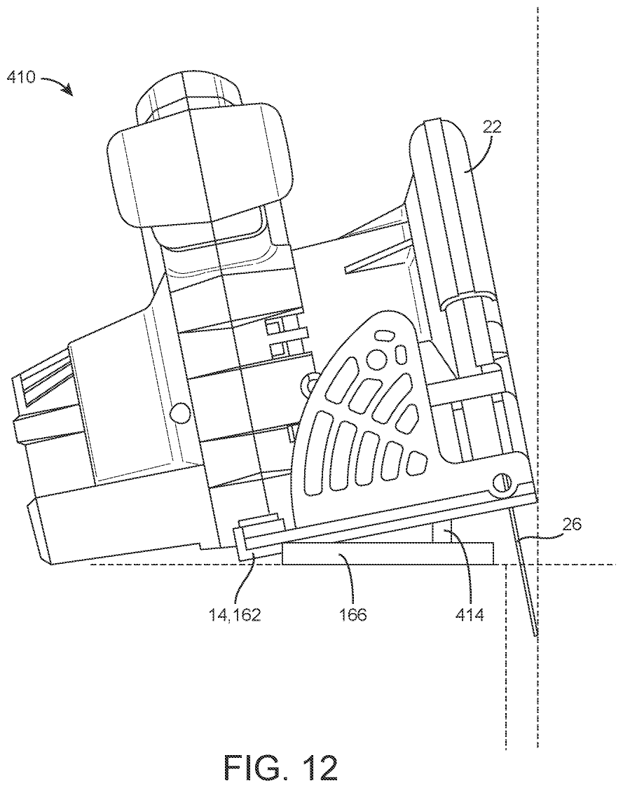

FIG. 12 illustrates a circular saw 410 according to another embodiment of the invention. The circular saw 410 is similar to the circular saw 10 discussed above with like features being represented with like features. The circular saw 410 includes a negative bevel feature such that the inner portion 166 of the base 14 is pivotable in an opposite direction than described above with regard to adjusting the bevel angle. That is, the bevel angle described above with regard to FIGS. 5-7 is a positive bevel angle, and the bevel angle achieved with the embodiment of FIG. 12 (in the opposite direction of the positive bevel) is a negative bevel angle. The inner portion 166 of the base 14 includes deployable risers 414 that may be positioned between the inner portion 166 and the outer portion 162 of the base 14 to position the outer portion 162 above the inner portion 166. As illustrated in FIG. 12, when the saw blade 26 is at the negative bevel angle, the saw blade 26 is able to cut closer to a vertical surface (e.g., a wall0 than if the base 14 was flat on a surface.

Various features and advantages are set forth in the following claims.

1. A circular saw comprising:
a housing;
a motor disposed within the housing;
a spindle operable to be rotated by the motor;
a saw blade supported by the spindle for co-rotation therewith, the saw blade including a hub portion located at a center of the saw blade and a blade portion extending therefrom, the hub portion being offset from the blade portion to define a pocket between the blade portion and the hub portion; and
a fastener securing the saw blade to the spindle, the fastener being at least partially recessed within the pocket.

2. The circular saw of claim 1, wherein the fastener is configured as a bolt threaded to the spindle, and wherein the bolt includes a head recessed within the pocket.

3. The circular saw of claim 1, wherein the fastener is configured as a nut threaded to the spindle, and wherein the nut is recessed within the pocket.

4. The circular saw of claim 1, wherein the spindle defines a bore to receive the fastener.

5. The circular saw of claim 1, further comprising an arbor assembly to secure the saw blade to the spindle, the arbor assembly including the fastener, an inner flange positioned between the motor and the saw blade, and an outer flange positioned within the pocket.

6. The circular saw of claim 1, wherein the saw blade is a first saw blade and the circular saw further includes a second saw blade, the second saw blade configured to be alternately coupled to the spindle for co-rotation therewith, the second saw blade including a second hub portion located at a center of the second saw blade connectable to the spindle and a second blade portion, the second hub portion being co-planar with the second blade portion.

7. A circular saw comprising:
a base;
a housing supported by the base;
a motor disposed within the housing;
a blade guard coupled to the base; and
a blade cover on a side of the blade guard opposite the housing, the blade cover and the base defining an opening therebetween through which a saw blade can extend;
wherein the opening has a width of at least 10 millimeters.

8. The circular saw of claim 7, wherein the width of the opening is at least 12 millimeters.

9. The circular saw of claim 7, wherein the width of the opening is at least 15 millimeters.

10. The circular saw of claim 7, further comprising:
a spindle operable to be rotated by the motor;
a first a saw blade configured to be coupled to the spindle for co-rotation therewith, the first saw blade including a first hub portion located at a center of the first saw blade connectable to the spindle and a first blade portion extending therefrom and through the opening, the first hub portion being offset from the first blade portion to define a pocket between the first blade portion and the first hub portion; and
a second saw blade configured to be alternately coupled to the spindle for co-rotation therewith, the second saw blade including a second hub portion located at a center of the second saw blade connectable to the spindle and a second blade portion extending therefrom and through the opening, the second hub portion being co-planar with the second blade portion,
wherein a first distance between the blade cover and the first blade portion, when the first saw blade is coupled to the spindle for co-rotation therewith, is less than a second distance between the blade cover and the second blade portion when the second saw blade is alternately coupled to the spindle for co-rotation therewith.

11. A circular saw comprising:
a housing;
a motor disposed within the housing, the motor defining a motor outer diameter;
a base upon which the housing is supported, the base defining a workpiece contact surface along which a workpiece is slidable in a sliding direction, a top surface opposite the workpiece contact surface, a front end perpendicular to the sliding direction, and an opposite rear end perpendicular to the sliding direction, the base defining a length between the front end and the rear end;
a spindle operable to be rotated by the motor;
a saw blade supported by the spindle for co-rotation therewith about a rotational axis; and
a pivot joint proximate the rear end of the base, the pivot joint pivotably coupling the housing to the base about a pivot axis that is parallel with the rotational axis, permitting the saw blade to plunge into the workpiece in response to the housing being pivoted about the pivot axis toward the base,
wherein an outer diameter of the saw blade is 6 inches or less.

12. The circular saw of claim 11, wherein a ratio of the length of the base to the saw blade outer diameter is between 1.2 and 1.75.

13. The circular saw of claim 12, wherein the length of the base is 6.5 inches, and wherein the saw blade outer diameter is 4.5 inches.

14. The circular saw of claim 11, wherein a ratio between the saw blade outer diameter and the motor outer diameter is between 1.5 and 2.

15. The circular saw of claim 14, wherein the saw blade outer diameter is 4.5 inches, and wherein the motor outer diameter is 2.5 inches.

16. The circular saw of claim 11, wherein the housing defines a battery receptacle operable to receive a battery pack.

17. The circular saw of claim 16, wherein when the battery pack is received by the battery receptacle, a bottom surface of the battery pack defines a clearance with the workpiece contact surface of 0.25 inches or less.

18. The circular saw of claim 16, wherein the battery pack is positioned closer to the front end of the base than the rear end.

19. The circular saw of claim 11, wherein the battery pack includes a bottom that is approximately co-planar with the top surface of the base when the battery pack is received by the battery receptacle.

20. The circular saw of claim 11, wherein a spring biases the housing away from the base.

21.-31. (canceled)
